(19) United States
(12) Patent Application Publication
(10) Pub. No.: US 2008/0162829 A1
(43) Pub. Date: Jul. 3, 2008

(54) SELECTIVE GUARDED MEMORY ACCESS ON A PER-INSTRUCTION BASIS

(75) Inventors: Jeffrey W. Scott, Austin, TX (US); William C. Moyer, Dripping Springs, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: FREESCALE SEMICONDUCTOR, INC., Austin, TX (US)

(21) Appl. No.: 11/619,301

(22) Filed: Jan. 3, 2007

(51) Int. Cl. G06F 12/00

(52) U.S. Cl. 711/154; 711/E12.001

(57) ABSTRACT

A method includes receiving, at a processing device, a memory access instruction comprising a guarded access specifier representative of a guarded access policy. The method further includes performing, at the processing device, a memory access represented by the memory access instruction in accordance with the guarded access policy. A processing device includes a processor core configured to determine a guarded access policy for a memory access instruction based on a guarded access specifier of the memory access instruction. The processing device further includes a memory management unit configured to facilitate a memory access represented by the memory access instruction based on the guarded access policy.

### FIELD OF THE DISCLOSURE

The present disclosure relates generally to processing devices and more particularly to memory accesses in processing devices.

### BACKGROUND

Memory is said to be “well-behaved” if a referenced memory exists and is not defective, and if the effects of a single access to it are indistinguishable from the effects of multiple identical accesses to it. Data and instructions can be fetched out-of-order from well-behaved memory without causing undesired side effects. Control registers of input/output (I/O) devices and memory locations that do not exist typically are not considered “well-behaved” because an out-of-order access to such storage may cause an I/O device to perform unintended operations. Another example of memory that is not “well-behaved” is an access to a first-in, first-out buffer (FIFO), where the act of accessing the FIFO causes the FIFO to pop the value provided. In this case, the access cannot be repeated or provided out of order because a different value will then be present in the FIFO.

To accommodate memory that is not “well-behaved,” many processing systems implement a guarded access policy whereby all prior issued memory accesses must be completed without exceptions before a memory access to a guarded memory location is permitted to be issued, thereby preventing out-of-order access to the guarded memory location. In conventional systems, memory locations are identified as guarded or unguarded on a page-by-page basis. However, in most implementations, non-well-behaved memory locations constitute only a small portion of a memory page. Thus, any memory access to any memory location of a memory page identified as guarded is performed as a guarded memory access even though the majority of memory accesses to the memory page are to well-behaved memory locations, thereby resulting in a significant delay in processing memory accesses to well-behaved memory locations, which consequently decreases system performance. Accordingly, an improved technique for implementing guarded memory accesses would be advantageous.

### BRIEF DESCRIPTION OF THE DRAWINGS

The present disclosure may be better understood, and its numerous features and advantages made apparent to those skilled in the art by referencing the accompanying drawings.

FIG. 1 is a diagram illustrating a data processing system in accordance with at least one embodiment of the present disclosure.

FIG. 2 is a diagram illustrating a processor device of the data processing system of FIG. 1 in accordance with at least one embodiment of the present disclosure.

FIG. 3 is a diagram illustrating an example format of a memory access instruction having a guarded access specifier in accordance with at least one embodiment of the present disclosure.

FIG. 4 is a flow diagram illustrating a method for configuring a guarded access policy for a memory access based on a guarded access specifier of a memory access instruction in accordance with at least one embodiment of the present disclosure.

The use of the same reference symbols in different drawings indicates similar or identical items.

### DETAILED DESCRIPTION

In accordance with one aspect of the present disclosure, a method includes receiving, at a processing device, a memory access instruction comprising a guarded access specifier representative of a guarded access policy. The method further includes performing, at the processing device, a memory access represented by the memory access instruction in accordance with the guarded access policy.

In accordance with another aspect of the present disclosure, a processing device includes a processor core configured to determine a guarded access policy for a memory access instruction based on a guarded access specifier of the memory access instruction. The processing device further includes a memory management unit configured to facilitate a memory access represented by the memory access instruction based on the guarded access policy.

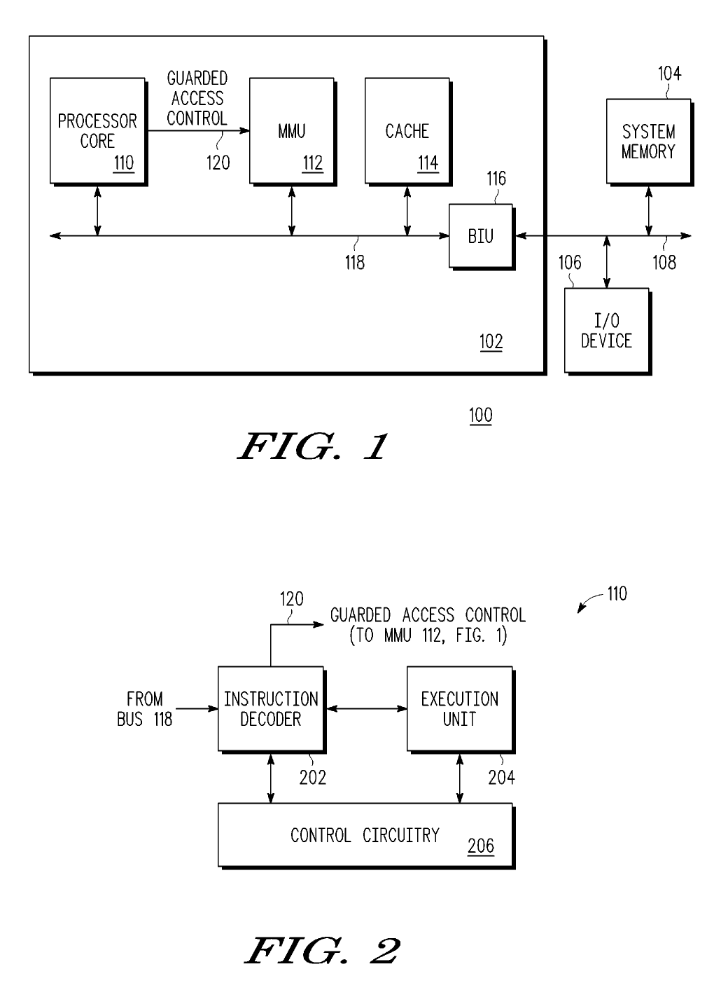

FIG. 1 illustrates a data processing system 100 utilizing guarded access policies that are adjustable on a per-instruction basis in accordance with at least one embodiment of the present disclosure. In the depicted example, the data processing system 100 includes a processing device 102, a system memory device 104 (e.g., random access memory (RAM)), and one or more input/output devices 106 connected via a bus 108. The processing device 102 includes a processor core 110, a memory management unit (MMU) 112, a cache 114, and a bus interface unit (BIU) 116 interconnected via a bus 118, whereby the BIU 116 serves as an interface between the bus 118 and the bus 108.

In operation, the processing device 102 executes instructions using the processor core 110, whereby instruction data and operand data can be accessed from the cache 114, the system memory device 104, the I/O device 106, or another source, and data resulting from the execution of the instructions can be provided for storage in the system memory device 104 or provided to the I/O device 106 via the BIU 116. In order to expedite memory accesses to devices external to the processing device 102 (e.g., the system memory device 104 and the I/O device 106), the cache 114 can be used to cache instruction data and related data.

The MMU 112 controls accesses to the cache 114 and memory accesses to devices external to the processing device 102, including the system memory device 104 and the I/O device 106. The MMU 112 can map the system memory device 104 and the bus interface of the I/O device 106 to corresponding memory addresses (e.g., virtual memory addresses) so that all accesses to the external devices are treated as a memory access. So as to reduce the possibility of disruptive memory accesses, the MMU 112 implements guarded access policies for memory accesses. In one embodiment, the MMU 112 can be configured so that each identified memory region (e.g., a page of memory) has a static, or default, guarded access policy, which can include a guard-active access policy whereby a memory access to the identified region is treated as a guarded memory access or a guard-inactive access policy whereby a memory access to the identified region is treated as a non-guarded memory access.

In addition to, or instead of, implementing a default memory region-based guarded access policy, in one embodiment, the processing device 102 is configured to implement a guarded access policy, or to adjust an implemented guarded access policy, on a per-instruction basis. Accordingly, in one embodiment, some or all memory access instructions (e.g., load and store instructions) can include or reference a guarded access specifier representative of the guarded access policy to be implemented when performing the memory access represented by the memory access instruction. The guarded access specifier can identify the specific guarded access policy to be implemented (e.g., a guarded access specifier having a first value for a guard-active access policy or having a second value for a guard-inactive access policy). Alternately, the guarded access specifier can specify that the default guarded access policy in place for the memory region associated with the memory access is to be overridden, or “flipped,” for the purposes of performing the memory access. To illustrate, a guarded access specifier having a first state can indicate that the default guarded access policy is to be maintained for the memory access, whereas a guarded access specifier having a second state can indicate that the opposite guarded access policy is to be implemented for the memory access (e.g., switched from a guard-active access policy to a guard-inactive access policy, or vice versa).

To implement the per-instruction guarded access policy, in one embodiment, the processor core 110 is configured to identify the guarded access specifier for a memory access instruction during processing of the memory access instruction and provide a guarded access control indicator 120 to the MMU 112 that is representative of the guarded access policy identified by the guarded access specifier. To illustrate, the guarded access specifier can be implemented in the memory access instruction as a bit field to store a value representative of the guarded access policy to be implemented for the memory access instruction. Accordingly, during decoding of the memory access instruction, the value of the bit field can be used to configure a particular state for the guarded access control indicator 120.

The MMU 112 is configured to receive the guarded access control indicator 120 and implement the indicated guarded access policy for the purposes of performing the memory access represented by the memory access instruction. The MMU 112, in one embodiment, combines the guarded access control indicator 120 with the static attribute (e.g., the static guarded attribute for the corresponding page) to determine a final guarded policy. The guarded access control indicator 120 can be provided along with the corresponding virtual address for each requested memory access.

FIG. 2 illustrates an example implementation of a portion of the processor core 110 of FIG. 1 with respect to the guarded access control indicator 120 in accordance with at least one embodiment of the present disclosure. In the depicted example, the processor core 110 includes an instruction decoder 202 configured to receive instructions via the bus 118 (FIG. 1) and to provide the guarded access control indicator 120 to the MMU 112 (FIG. 1). The processor core 110 further includes an execution unit 204 connected to the instruction decoder 202, as well as control circuitry 206 connected to the instruction decoder 202 and the execution unit 204. The control circuitry 206 includes circuitry to control the decoding and execution of instructions by the instruction decoder 202 and the execution unit 204.

In operation, the instruction decoder 202 receives instructions from an instruction buffer (not shown). Each instruction is decoded and then executed accordingly by the execution unit 204. If the instruction decoder 202 is decoding a memory access instruction that includes or references a guarded access specifier, the instruction decoder 202 provides the guarded access control indicator 120 to the MMU 112 as part of the memory access request, whereby the state of the guarded access control indicator 120 is based on the state indicated by the guarded access specifier. The operation of the execution unit 204 and the control circuitry 206 is known in the art and will not be described in more detail herein. The operation of instruction decoder 202 is only described to the extent necessary to describe the generation of the guarded access control indicator 120 as the rest of the instruction decoder 202 may operate as known in the art.

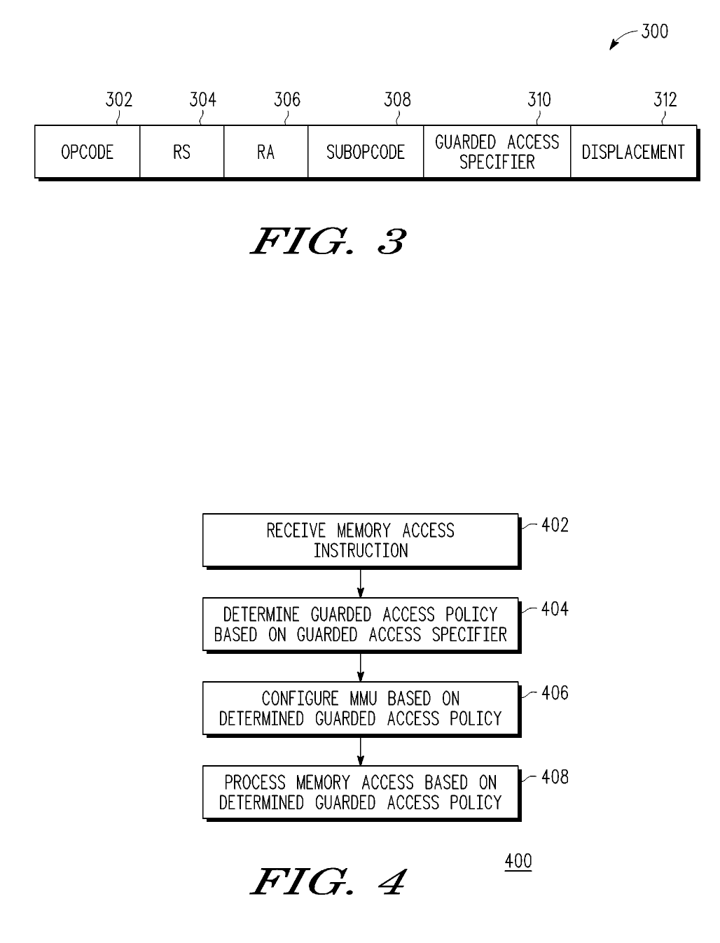

FIG. 3 illustrates an example format of a memory access instruction 300 in accordance with at least one embodiment of the present disclosure. The memory access instruction 300 includes an opcode field 302, a source register (RS) field 304, a base address register (RA) field 306, a subopcode field 308, a guarded access specifier field 310, and a displacement field 312. The values stored in the opcode field 302 and the subopcode field 308 are used to indicate the particular type of memory access instruction. For store-type memory access instructions, the value stored in the RS field 304 indicates a register (such as a general purpose register of the processing device 102, FIG. 1) that includes data to be stored in an external device (such as the system memory device 104, FIG. 1). The combination of the value stored in the RA field 306 and the value stored in the displacement field 312 are used to indicate the memory address of an external device to which the data in the register indicated by the value stored in the RS field 304 is to be stored or provided. For example, the value in the RA field 306 may indicate one of the general purpose registers of the processing device 102 that stores a base address value. The value stored in the displacement field 312 (which, in one embodiment, may be a positive or negative value) is then added to the base address value to provide the destination memory address for the memory access instruction. For load-type memory access instructions, the value stored in the RS field 304 indicates a register (such as a general purpose register of the processing device 102, FIG. 1) in which data from a memory is to be stored. The combination of the value stored in the RA field 306 and the value stored in the displacement field 312 are used to indicate where in the system memory device 104 the data is to be accessed from. For example, the value in the RA field 306 may indicate one of the general purpose registers of the processing device 102 that stores a base address value. The value stored in the displacement field 312 (which, in one embodiment, may be a positive or negative value) is then added to the base address value to provide the source address for the load-type memory access instruction.

The memory access instruction 300 also includes the guarded access specifier. In one embodiment, the guarded access specifier can be implemented as a separate field within memory access instruction 300, such as the guarded access specifier field 310. In another embodiment, the guarded access specifier can be implemented as a portion of another field of memory access instruction 300, such as, for example, by overloading the opcode field 302, the subopcode field 308, or a combination thereof, or, for example, by using a bit of the displacement field 312, the RS field 304, or the RA field 306. Note that while a particular example format of a memory access instruction having a guarded access specifier is illustrated, the memory access instruction can have any of a variety of formats and may use any other type of addressing mode without departing from the scope of the present disclosure.

In one embodiment, the guarded access specifier included within the memory access instruction 300 allows for the indication of the guarded access policy to be used for the memory access instruction 300. For example, if the guarded access specifier field 310 is a single bit, then a first value (i.e., state) of the bit can indicate that one of a guard-active access policy or a guard-inactive access policy is to be used, whereas a second value of the bit can indicate that the other of the guard-active access policy or the guard-inactive access policy is to be used. Alternately, the first value of the bit can indicate that the default guarded access policy in place for the memory region to be accessed during execution of the memory access instruction 300 is to be maintained, whereas the second value of the bit can indicate that the default guarded access policy is to be overridden (e.g., to flip from a guard-active access policy to a guard-inactive access policy or vice versa). In this manner, a memory access instruction that includes guarded access specifier can cause the MMU 112 to implement a different guarded access policy than a different memory access instruction that also includes a guarded access specifier.

FIG. 4 illustrates an example method 400 for executing a memory access based on a guarded access specifier of an instruction initiating the memory access in accordance with at least one embodiment of the present disclosure. For ease of discussion, the method 400 is described in the context of the embodiments of FIGS. 1-3.

The method 400 initiates at block 402, whereby a memory access instruction having a guarded access specifier, such as the memory access instruction 300 (FIG. 3), is received at the processor core 110 of the processing device 102 for execution. At block 404, the guarded access policy to be implemented for the performance of the memory access represented by the instruction is determined based on the guarded access specifier within the instruction, during, for example, decoding of the memory access instruction. As described above, guarded access specifier can be implemented as one or more bits of one or more fields of the memory access instruction, whereby the value represented by the one or more bits can identify a specific guarded access policy (e.g., a guard-active access policy or a guard-inactive access policy). Alternately, the value represented by the one or more bits can identify whether the default guarded access policy for the memory portion involved, which may be provided by one or more page attribute bits stored within MMU 112 and associated with the memory location address, is to be maintained or overridden.

After determining the guarded access specifier, at block 406 the MMU 112 of the processing device 102 is configured to implement the guarded access policy determined at block 404. In one embodiment, the processor core 110 configures the guarded access control indicator 120 to have a particular state based on the guarded access specifier. To illustrate, when the guarded access specifier has a first value (e.g., a logic “0”) indicating a guard-inactive access policy, the guarded access control indicator 120 is configured to have a first state (e.g., a logic “0”) so as to direct the MMU 112 to process the corresponding memory access as a non-guarded access. Conversely, when the guarded access specifier has a second value (e.g., a logic “1”) indicating a guard-active access policy, the guarded access control indicator 120 is configured to have a second state (e.g., a logic “1”) so as to direct the MMU 112 to process the corresponding memory access as a guarded access.

Based on the identified configuration, the MMU 112 processes the memory access represented by the memory access instruction at block 408. If the memory access is identified as a guarded memory access, the MMU 112, the processor core 110, and the BIU 116 cooperate to ensure that the memory access is only performed if no preceding access or instruction causes, or will cause, an exception condition which would potentially cause the guarded memory access to be discarded or aborted. If the memory access is not guarded, then the MMU 112 and the BIU 116 may cause the memory access to be performed out of order, or in a speculative manner, thus potentially improving performance by allowing the memory access to begin and complete earlier than if a delay was required to determine the exception status of all previous instructions prior to the memory access instruction. Thus, the use of an instruction-based specifier allows for fine-grained control over the ordering and speculation of memory accesses to regions of memory that are not “well-behaved” compared to those that are “well-behaved.” Because one or more locations in a page of memory mapped by a single page attribute may not require strict ordering, even though other locations in the memory page require a strictly ordered, non-speculative treatment, utilization of different instruction-based guarded attribute specifiers for the different memory access instructions accessing these different locations of memory can result in better throughput and processing performance than using a single page-wide specification as utilized in conventional MMUs. Therefore, the flow of method 400 provides an example of how a guarded access specifier of a memory access instruction can be used to configure a guarded access policy for the memory access instruction on a per-instruction basis rather than, or in addition to, a per-page or per-segment basis.

In this document, relational terms such as “first” and “second”, and the like, may be used solely to distinguish one entity or action from another entity or action without necessarily requiring or implying any actual such relationship or order between such entities or actions. The terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including”, “having”, or any variation thereof, as used herein, are defined as comprising. The term “coupled”, as used herein with reference to electro-optical technology, is defined as connected, although not necessarily directly, and not necessarily mechanically.

The terms “assert” or “set” and “negate” (or “deassert” or “clear”) are used when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

As used herein, the term “bus” is used to refer to a plurality of signals or conductors that may be used to transfer one or more various types of information, such as data, addresses, control, or status. The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof.

What is claimed is:

1. A method comprising:
receiving, at a processing device, a memory access instruction comprising a guarded access specifier representative of a guarded access policy; and
performing, at the processing device, a memory access represented by the memory access instruction in accordance with the guarded access policy.

2. The method of claim 1, wherein performing the memory access comprises:
decoding the memory access instruction to determine the guarded access specifier;
determining the guarded access policy based on the guarded access specifier; and
configuring the processing device to implement the guarded access policy; and
executing the memory access instruction in response to configuring the processing device.

3. The method of claim 2, wherein decoding the memory access instruction to determine the guarded access specifier comprises decoding a bit of an opcode field of the memory access instruction to determine the guarded access specifier.

4. The method of claim 2, wherein decoding the memory access instruction to determine the guarded access specifier comprises decoding a bit of an displacement field of the memory access instruction to determine the guarded access specifier.

5. The method of claim 1, wherein performing the memory access comprises:
performing a guarded memory access in response to the guarded access specifier having a first state.

6. The method of claim 5, wherein performing the memory access comprises:
performing an unguarded memory access in response to the guarded access specifier having a second state.

7. The method of claim 1, wherein performing the memory access comprises:
performing an unguarded memory access in response to the guarded access specifier having a select state.

8. The method of claim 1, further comprising:
overriding a default guarded access policy for a memory region including a memory location associated with the memory access instruction in response to the guarded access specifier having a first state.

9. The method of claim 8, further comprising:
maintaining the default guarded access policy for the memory region in response to the guarded access specifier having a second state.

10. The method of claim 1, further comprising:
maintaining a default guarded access policy for a memory region including a memory location associated with the memory access instruction in response to the guarded access specifier having a select state.

11. A processing device comprising:
a processor core configured to determine a guarded access policy for a memory access instruction based on a guarded access specifier of the memory access instruction; and
a memory management unit configured to facilitate a memory access represented by the memory access instruction based on the guarded access policy.

12. The processing device of claim 11, wherein the processor core comprises:
an instruction decoder configured to decode the memory access instruction to determine the guarded access policy represented by the guarded access specifier and to provide a guarded access control indicator for receipt by the memory management unit.

13. The processing device of claim 12, wherein the memory management unit is configured to implement a first guarded access policy for the memory transaction in response to the guarded access control indicator having a first state.

14. The processing device of claim 13, wherein the memory management unit is configured to implement a second guarded access policy for the memory transaction in response to the guarded access control indicator having a second state.

15. The processing device of claim 14, wherein the first guarded access policy comprises a guard-active access policy and the second guarded access policy comprises a guard-inactive access policy.

16. The processing device of claim 11, wherein the memory management unit is configured to override a default guarded access policy for a memory region including a memory location associated with the memory access instruction in response to in response to the guarded access specifier having a first state.

17. The processing device of claim 16, wherein the memory management unit is configured to maintain the default guarded access policy for the memory region in response to the guarded access specifier having a second state.

18. The processing device of claim 11, wherein the guarded access specifier comprises a bit of an opcode field of the memory access instruction.

19. The processing device of claim 18, wherein the guarded access specifier comprises a bit of a displacement field of the memory access instruction.
